(19) United States
(12) Patent Application Publication
(10) Pub. No.: US 2025/0307299 A1
(43) Pub. Date: Oct. 2, 2025

(54) METHOD FOR RETRIEVING INFORMATION FOR SIMILAR CASES AND COMPUTER DEVICE USING THE SAME

(71) Applicant: NATIONAL APPLIED RESEARCH LABORATORIES, Taipei City (TW)

(72) Inventors: Bou-Wen LIN, Taipei City (TW); Kuan-Ju WANG, Taipei City (TW); Chih-Yu AN, Taipei City (TW)

(21) Appl. No.: 18/655,432

(22) Filed: May 6, 2024

(30) Foreign Application Priority Data
Mar. 28, 2024 (TW) 113111822

(51) Int. Cl. G06F 16/35; G06F 16/383

(52) U.S. Cl. CPC G06F 16/353; G06F 16/383; G06Q 50/184

(57) ABSTRACT

A method for retrieving information for similar cases is provided, which includes the following steps: obtaining a technical context; performing a text cleaning process on the technical context to generate a cleaned technical context; performing word segmentation on the cleaned technical context to obtain a plurality of words; identifying one or more first features and second features using the words associated with the technical context; filtering the one or more second features using a subset selected from the one or more first features; retrieving candidate word vectors of candidate cases from a database using the filtered second features; performing word vector analysis on the words to generate a plurality of word vectors; and determining a most similar case associated with the technical context according to a similarity score for each candidate case calculated using the word vectors and the candidate word vectors corresponding to each candidate case.

### FIELD OF THE INVENTION

The present disclosure relates to computer devices, and, in particular, a method for retrieving information for similar cases and a computer device using the same.

### BACKGROUND

After completing research and development, an inventor may wish to conduct a thorough search of a patent database to determine whether any similar patent applications exist. Similarly, medical device designers or manufacturers may also seek to ensure that their developed products do not closely resemble any existing devices listed in a database. However, such searches can be challenging due to the comprehensive nature thereof, and large database population.

### SUMMARY OF THE DISCLOSURE

In an aspect of the present disclosure, a method for retrieving information for similar cases is provided. The method includes the following steps: obtaining a technical context; performing a text cleaning process on the technical context using a first machine-learning model to generate a cleaned technical context; performing word segmentation on the cleaned technical context using a second machine-learning model to obtain a plurality of words associated with the technical context; identifying one or more first features and one or more second features using the words associated with the technical context using a first classification model and a second classification model, respectively; filtering the one or more second features using a subset selected from the one or more first features; retrieving candidate word vectors of one or more candidate cases from a database using the filtered second features; performing word vector analysis on the words associated with the technical context using a third machine-learning model to generate a plurality of word vectors; and determining a most similar case associated with the technical context according to a similarity score for each candidate case calculated using the word vectors and the candidate word vectors corresponding to each candidate case.

In another aspect of the present disclosure, a computer device for retrieving information for similar cases is provided. The computer device includes: a memory having computer executable instructions stored therein; and a processor coupled to the memory. The computer executable instructions cause the processor to perform operations, and the operations include: obtaining a technical context; performing a text cleaning process on the technical context using a first machine-learning model to generate a cleaned technical context; performing word segmentation on the cleaned technical context using a second machine-learning model to obtain a plurality of words associated with the technical context; identifying one or more first features and one or more second features using the words associated with the technical context using a first classification model and a second classification model, respectively; filtering the one or more second features using a subset selected from the one or more first features; retrieving candidate word vectors of one or more candidate cases from a database using the filtered second features; performing word vector analysis on the words associated with the technical context using a third machine-learning model to generate a plurality of word vectors; and determining a most similar case associated with the technical context according to a similarity score for each candidate case calculated using the word vectors and the candidate word vectors corresponding to each candidate case.

### BRIEF DESCRIPTION OF THE DRAWINGS

Aspects of the present disclosure are best understood from the following detailed description when read with the accompanying figures. It is noted that in accordance with the standard practice in the industry, various features are not drawn to scale. In fact, the dimensions of the various features may be arbitrarily increased or reduced for clarity of discussion.

FIG. 1 is a block diagram of a computer system in accordance with an embodiment of the present disclosure.

FIG. 2 is a flowchart of a training procedure for similar patent applications in accordance with some embodiments of the present disclosure.

FIG. 3 is a flowchart of a searching procedure for similar patent applications in accordance with some embodiments of the present disclosure.

FIG. 4 is a flowchart of a training procedure for similar medical devices in accordance with some embodiments of the present disclosure.

FIG. 5 is a flowchart of a search procedure for similar medical devices in accordance with some embodiments of the present disclosure.

FIG. 6 is a flowchart of a method for retrieving information for similar cases in accordance with some embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION

The following disclosure provides many different embodiments, or examples, for implementing different features of the provided subject matter. Specific examples of operations, components, and arrangements are described below to simplify the present disclosure. These are, of course, merely examples and are not intended to be limiting. For example, a first operation performed before or after a second operation in the description may include embodiments in which the first and second operations are performed together, and may also include embodiments in which additional operations may be performed between the first and second operations. For example, the formation of a first feature over, on or in a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Time relative terms, such as “prior to,” “before,” “posterior to,” “after” and the like, may be used herein for ease of description to describe one operations or feature's relationship to another operation(s) or feature(s) as illustrated in the figures. The time relative terms are intended to encompass different sequences of the operations depicted in the figures. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Relative terms for connections, such as “connect,” “connected,” “connection,” “couple,” “coupled,” “in communication,” and the like, may be used herein for ease of description to describe an operational connection, coupling, or linking one between two elements or features. The relative terms for connections are intended to encompass different connections, coupling, or linking of the devices or components. The devices or components may be directly or indirectly connected, coupled, or linked to one another through, for example, another set of components. The devices or components may be wired and/or wireless connected, coupled, or linked with each other.

As used herein, the singular terms “a,” “an,” and “the” may include plural referents unless the technical context clearly indicates otherwise. For example, reference to a device may include multiple devices unless the technical context clearly indicates otherwise. The terms “comprising” and “including” may indicate the existences of the described features, integers, steps, operations, elements, and/or components, but may not exclude the existences of combinations of one or more of the features, integers, steps, operations, elements, and/or components. The term “and/or” may include any or all combinations of one or more listed items.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

The nature and use of the embodiments are discussed in detail as follows. It should be appreciated, however, that the present disclosure provides many applicable inventive concepts that can be embodied in a wide variety of specific contexts. The specific embodiments discussed are merely illustrative of specific ways to embody and use the disclosure, without limiting the scope thereof.

### Example 1: Searching for Similar Patent Applications Using Technical Context

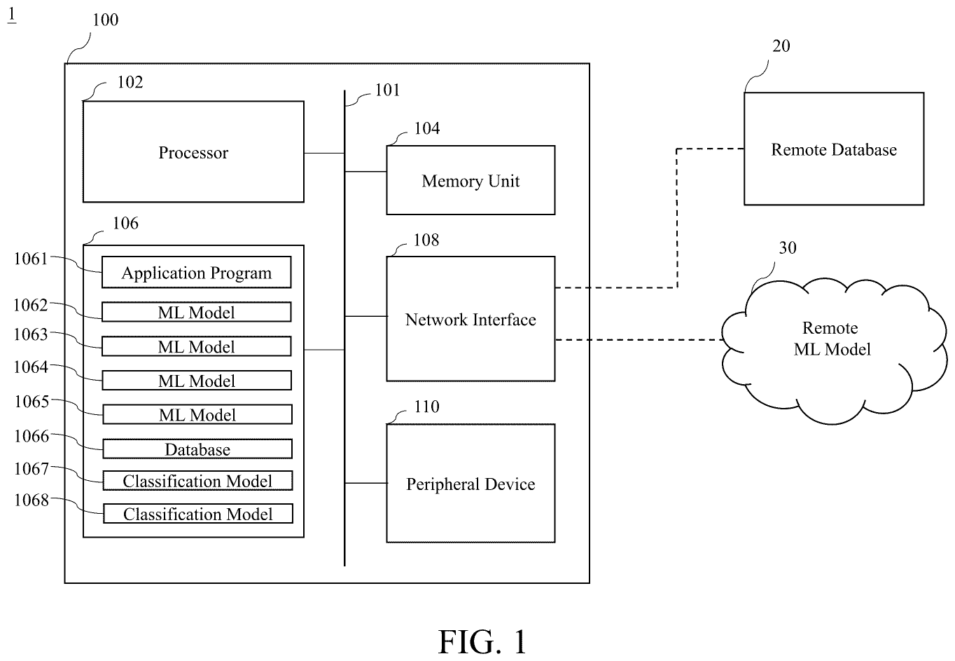

FIG. 1 is a block diagram of a computer system in accordance with an embodiment of the present disclosure.

In some embodiments, the computer system 1 may include a computer device 100, a remote database 20, and a remote machine-learning (ML) model 30. The computer device 100 may comprise, but is not limited to, mobile phones, desktop computers, laptops, personal digital assistants (PDAs), smartphones, tablets, laptops, multi-processor systems, microprocessor-based or programmable consumer electronics, game consoles, set-top boxes, or any other suitable devices with computing and network capabilities. The computer device 100 may include a processor 102, a memory unit 104, a storage device 106, a network interface 108, and one or more peripheral devices 110 that are electrically connected through bus 101, as depicted in FIG. 1.

In some embodiments, the processor 102 may be or include one or more central processor units (CPUs), microprocessors, co-processing entities, field programmable gate array (FPGAs), application-specific integrated circuits (ASICs), or any other circuitry having processing capability, but the present disclosure is not limited thereto. The memory unit 104 may be a volatile memory such as a dynamic random access memory (DRAM) or a static random access memory (SRAM) which serves as an execute space and stores intermediate data for an application program 1061.

In some embodiments, the network interface 108 supports wired and/or wireless transmission protocols that enable communication with remote database 20 and remote machine-learning model 30. The wired transmission protocols may include Ethernet, Universal Serial Bus (USB), Inter Integrated Circuit (I2C), Serial Peripheral Interface (SPI), etc., but the present disclosure is not limited thereto. The wireless transmission protocols may include Wi-Fi (802.11), Global System for Mobile Communications (GSM), Enhanced Data rates for GSM Evolution (EDGE), Time Division-Synchronous Code Division Multiple Access (TD-SCDMA), Long Term Evolution (LTE), 4-th Generation (4G), 5-th Generation (5G), 6-th Generation (6G), ultra-wideband (UWB), infrared (IR) protocols, near field communication (NFC) protocols, Wibree, Bluetooth protocols, wireless universal serial bus (USB) protocols, but the present disclosure is not limited thereto.

In some embodiments, the remote database 20 may be a public patent database initiated by U.S. Patent and Trademark Office (USPTO) or any other intellectual property authority to provide public access to a collection of granted patents and published patent applications. Alternatively, the remote database 20 may be a public medical-device database (e.g., FDA 510(k) database or OpenFDA database) initiated by the Food and Drug Administration (FDA) in the United States. The remote machine-learning model 30 can be a pre-existing, large generative pre-trained transformer (GPT) model sourced from online platforms.

In some embodiments, the storage device 106 may be a non-volatile memory such as a hard disk drive (HDD), a flash memory, a read-only memory, SD memory card, memory sticks, ferroelectric random access memory (FeRAM), resistive random access memory (RRAM), etc., but the present disclosure is not limited thereto. In some embodiments, the storage device 106 stores the application program 1061, machine-learning models 1062 to 1065, and a database 1066. The application program 1061 may include instructions to be executed by the processor 102 perform operations for retrieving information for similar patents based on a technical context, as will further explained.

In some embodiments, the technical context may include a title and an abstract of a technical concept, which can be input by a user through the peripheral device 110 or other input methods such as speech recognition, optical character recognition, etc. Additionally, the technical context may also include the title and abstract of each granted patent (i.e., also known as “patent”) and published patent application (i.e., also known as “patent application”) retrieved from the remote database 20.

In some embodiments, the title of the technical concept is optional, and it indicates that the application program 1061 can perform the procedure for finding similar patent applications using the abstract with or without the title of the technical concept.

In some embodiments, the classification of technologies in each granted patent (i.e., also known as “patent”) and published patent application (i.e., also known as “patent application”) can be done using one or more IPC codes. These granted patents and published patent applications can be collectively regarded as patent applications. These codes are structured into five levels, namely sections, classes, subclasses, main groups, and subgroups. A complete IPC code, also known as a 5-level IPC code, includes all five levels, while a high-level IPC code, or a 3-level IPC code, includes only the top three levels (sections, classes, and subclasses). During the training of machine-learning models and the search for similar patent applications, both the 5-level IPC code and its corresponding 3-level IPC code will be utilized.

### Training Procedure for Example 1

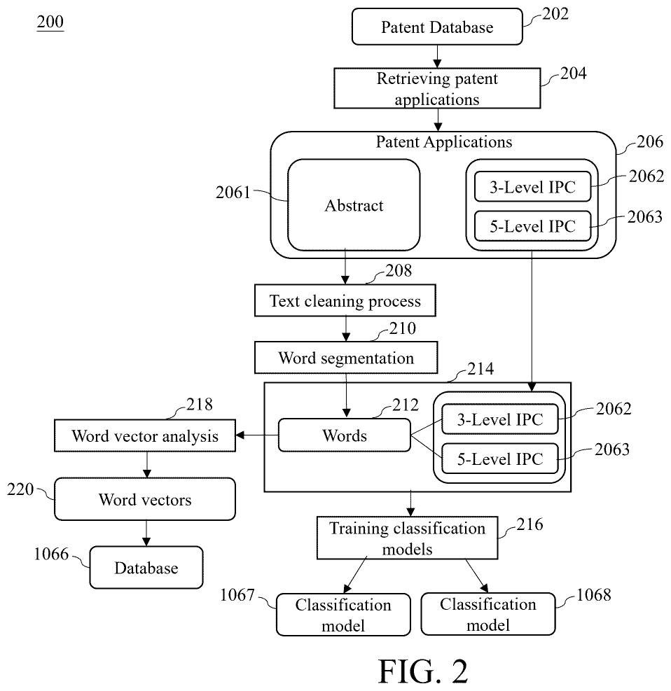

FIG. 2 is a flowchart of a training procedure for similar patent applications in accordance with some embodiments of the present disclosure.

In some embodiments, during training procedure 200, the processor 102 may retrieve the title, abstract, and associated patent classification codes of each patent application from patent database 202 (step 204). For example, the patent classification codes may be International Patent Classification (IPC) codes, cooperative patent classification (CPC) codes, etc., but the present disclosure is not limited thereto. For purposes of description, the IPC codes are used in the following embodiments.

In some embodiments, the processor 102 may execute the machine-learning model 1062 to perform a text cleaning process (block 208) on the abstract 2061 of each patent application 206. The text cleaning process involves removing adverbs, punctuations (e.g., periods, commas, question marks), stopwords, and other unnecessary elements (e.g., accent marks, diacritics, etc.) from the information (e.g., patent or publication number, title, abstract, filing date, application no., assignee(s), applicant(s), etc.) of each patent application, which may be in English, traditional Chinese, simplified Chinese, or other language, retrieved from patent database 202 (e.g., USPTO public patent database), so primary technical content and/or keywords will be retained in the raw text of the cleaned context. The machine-learning model 1062 used in this process may be an existing natural language processing (NLP) model or a pre-trained generative transformer (GPT) model that can identify relationships between the various elements of language, such as the letters, words, phrases, and sentences present within the technical context.

Subsequently, the processor 102 may execute the machine-learning model 1063 to perform word segmentation on the title of the cleaned technical context to generate one or more first words associated with the title. The processor 102 may then execute the machine-learning model 1064 to perform word segmentation (block 210) on the abstract of the cleaned technical context to generate a plurality of second words 212 associated with the abstract. In some embodiments, the machine-learning models 1063 and 1064 may be different models. Alternatively, the machine-learning models 1063 and 1064 may be the same model. Herein, the first words and the second words can be technical terms with one or more words.

In some embodiments, the processor 102 may obtain a variety of first entries by pairing each second word 212 and each 3-level IPC code 2062 found in each patent application (block 214), and the processor 102 can train or build the classification model 1067 using the first entries (block 216). Additionally, the processor 102 may obtain a variety of second entries by pairing each second word and each 5-level IPC code 2063 found in each patent application (block 214), and the processor 102 can train or build the classification model 1068 using the second entries (block 216).

Alternatively, in some embodiments, the processor 102 may obtain a variety of first entries by pairing each first word and each 3-level IPC code found in each patent application, and the processor 102 can build a classification model 1067 using the first entries. Additionally, the processor 102 may obtain a variety of second entries by pairing each second word and each 5-level IPC code found in each patent application, and the processor 102 can build the classification model 1068 using the second entries.

In some embodiments, the classification models 1067 and 1068 may be multinomial Naive Bayes classifiers, support vector machines (SVM), lookup tables, dictionary files, etc., but the present disclosure is not limited thereto.

In some embodiments, the processor 102 may execute the machine-learning model 1065 to conduct word vector analysis of the second words 212 generated by the machine-learning model 1064 (block 218) to generate a plurality of word vectors 220 associated with the second words 212 within each patent application, and build the database 1066 using the generated word vectors 220. In some embodiments, the database 1066 may be a word-vector model that is trained using the generated word vectors 220.

For purposes of description, Cases 1-1 to 1-6 are used during the training procedure in Example 1. Table 1 illustrates information for Case 1-1 retrieved from the remote database 20.

TABLE 1

| | |
|---|---|
| Patent or Publication | U.S. Pat. No. 10687902B2 |
| Number | |
| Title | Surgical Navigation System and Auxiliary Positioning Assembly Thereof |
| Filing Date | May 25, 2018 |
| Application No. | 15/990,366 |
| Patent Office | US |
| Assignee | EPED Inc., <Kaohsiung> {TW} |
| Inventors(s) | Huang, Ta-Ko <Kaohsiung > {TW}, Huang, Jerry T. < Kaohsiung> {TW} |
| Abstract | The present invention provides a surgical navigation system |
| | including a positioning device, a processing device and a display |
| | device. The positioning device includes an auxiliary positioning |
| | assembly capable of wearing or fixing around a patient's affected part |
| | and an optics positioning assembly. The optics positioning assembly |
| | can sense the position of the auxiliary positioning assembly to form |
| | a positioning information. The processing device can receive the |
| | positioning information and integrate the positioning information |
| | with a medical image to form a navigation information, so that the |
| | navigation information is displayed on the display device through a |
| | stereoscopic image or a sectional image. Therefore, the doctor can |
| | accurately perform the relevant surgical operations on the patient's |
| | affected part through the displayed information. |
| IPC | A61B 34/20; A61B 90/50 |

In some embodiments, with regard to Case 1-1 shown in Table 1, the processor 102 may execute the machine-learning model 1062 to perform a text cleaning process on the title and abstract of Case 1-1. The processor 102 may then execute the machine-learning model 1064 to perform word segmentation on the abstract to generate a plurality of second words, such as “surgical navigation system”, “positioning device”, “processing device”, “display device”, “auxiliary positioning assembly”, “optics positioning assembly”, “positioning information”, “medical image”, “navigation information”, “stereoscopic image”, “sectional image”, “surgical operations”, etc. Moreover, Case 1-1 has two TPC codes, such as “A61B 34/20” and “A61B 90/50”, and the two IPC codes have a common 3-level TPC code, namely, “A61B”. Accordingly, the processor 102 may use “A61B” as the 3-level IPC codes for Case 1-1. Additionally, the processor 102 may further use “A61B 34/20” and “A61B 90/50” as the 5-level IPC codes for Case 1-1.

In some embodiments, the processor 102 may generate the first entries for the classification model 1067 by pairing each of the second words and the 3-level IPC code “A61”. For example, the first entries may include the following combinations, such as (“surgical navigation system”, “A61i”), (“positioning device”, “A61i”), (“processing device”, “A61”), and others. Additionally, the processor 102 may further generate the second entries for the classification model 1068 by pairing each of the second words and each of the 5-level IPC codes “A61B 34/20” and “A61B 90/50”. For example, the second entries may include the following combinations, such as (“surgical navigation system”, “A61B 34/20”), (“surgical navigation system”, “A61B 90/50”), (“positioning device”, “A61B 34/20”), (“positioning device”, “A61B 90/50”), and others. Therefore, the processor 102 can build the classification models 1067 and 1068 using the first entries and the second entries, respectively.

In some embodiments, the processor 102 may execute the machine-learning model 1065 to conduct word vector analysis on each of the second words to generate a word vector for each second word. For example, the machine-learning model 1065 may convert each second word into a respective word vector using the technique of “word to vector” (e.g., Word2vec), with each word vector having N dimensions, where N is a positive integer. Accordingly, the processor 102 can store the word vectors corresponding to Case 1-1 to the database 1066.

Tables 2 to 6 illustrate information for Cases 1-2 to 1-6 retrieved from the remote database 20, respectively.

TABLE 2

| | |
|---|---|
| Patent or Publication | US20150140505A1 |
| Number | |
| Title | COMPUTER-AIDED POSITIONING AND NAVIGATION |
| | SYSTEM FOR DENTAL IMPLANT |
| Filing Date | Jan. 27, 2015 |
| Application No. | 14/606,679 |
| Patent Office | US |
| Assignee | National Chung Cheng University <Chia-Yi> {TW} |
| Inventors(s) | LIN, Yen-Kun <New Taipei City> {TW}, YAU, Hong-Tzong |
| | <Chia-Yi County> {TW} |
| Abstract | A computer-aided positioning and navigation system for dental |
| | implant includes a computer system having built therein a dental |
| | implant planning software and providing a 3D digital human tissues |
| | model to create an implant navigation information, a positioning |
| | assistive device including a body providing a positioning portion and |
| | a guide portion and a connection member carrying an optical |
| | positioning device, one or multiple optical capture devices, and a |
| | display device electrically connected to the computer system. The |
| | computer system controls the optical capture device to capture |
| | images and drives the display device to display a part of the content |
| | of the 3D digital human tissues model and the implant navigation |
| | information. |
| IPC | A61B 1/24 ; A61B 19/00 ; A61C 1/08 |

TABLE 3

| | |
|---|---|
| Patent or Publication | US20140080086A1 |
| Number | |
| Title | Image Navigation Integrated Dental Implant System |
| Filing Date | Sep. 20, 2012 |
| Application No. | 13/623,586 |
| Patent Office | US |
| Assignee | CHEN, Roger (4357195) <New Taipei City> {TW} |
| Inventors(s) | CHEN, Roger (4357195) <New Taipei City> {TW} |
| Abstract | An image navigation integrated dental implant system includes a |
| | control unit for storing and transmitting data streams, a scan module |
| | electrically connected to the control unit for scanning and taking the |
| | pictures of the soft tissue and hard tissue of the parenchyma of the |
| | oral cavity of a patient and the related external skin color and |
| | transmitting the obtained data to the control unit, a design module |
| | electrically connected to the control unit for receiving the oral cavity |
| | data from the control unit and using the data to design a oral cavity |
| | simulation diagram, and a navigator module electrically connected to |
| | the control unit for receiving the oral cavity data and photographing |
| | the oral cavity and then providing a picture to guide the dentist to |
| | perform the dental implant surgery. |
| IPC codes | A61B 6/14 |

TABLE 4

| | |
|---|---|
| Patent or Publication | U.S. Pat. No. 10658975B2 |
| Number | |
| Title | Semiconductor Device and Method |
| Filing Date | Apr. 5, 2019 |
| Application No. | 13/623,586 |
| Patent Office | US |
| Assignee | Taiwan Semiconductor Manufacturing Company, Ltd. < Hsinchu> {TW} |
| Inventors(s) | Jou, Chewn-Pu <Hsinchu> {TW}, KUO, Feng Wei <Zhudong |
| | Township> {TW}, [1] CHEN, Huan-Neng <Taichung City> {TW}, |
| | CHO, LAN-CHOU <Hsinchu> {TW} |
| Abstract | A circuit includes a first digital controlled oscillator and a second |
| | digital controlled oscillator coupled to the first digital controlled |
| | oscillator. A skew detector is connected to determine a skew between |
| | outputs of the first digital controlled oscillator and the second digital |
| | controlled oscillator, and a decoder is utilized to output a control |
| | signal, based on the skew, to modify a frequency of the first digital |
| | controlled oscillator using a switched capacitor array to reduce or |
| | eliminate the skew. |
| IPC | H01F 5/04 ; H01F 19/04 ; H01F 27/28 ; H01F 38/14 ; H03B 5/12 ; |
| | H03L 7/00 ; H03L 7/099 |

TABLE 5

| | |
|---|---|
| Patent or Publication | U.S. Pat. No. 10658975B2 |
| Number | |
| Title | METHOD FOR PROTECTING CORNEAL ENDOTHELIAL |
| | CELLS FROM THE IMPACT CAUSED BY AN EYE SURGERY |
| Filing Date | Mar. 13, 2018 |
| Application No. | 15/920,005 |
| Patent Office | US |
| Assignee | Chang Gung Memorial Hospital, Linkou <Taoyuan City> {TW} |
| Inventors(s) | CHENG, Chao-Min <Hsinchu> {TW}, MA, Hui-Kang <Taoyuan |
| | City> {TW}, CHEN, Hung-Chi <Taoyuan City> {TW}, HSUEH, |
| | Yi-Jen <Taoyuan City> {TW} |
| Abstract | A method for protecting corneal endothelial cells from the impact |
| | caused by an eye surgery is disclosed. The ophthalmic composition |
| | is administered to a patient's eye continuously for at least five days |
| | before an eye surgery for reducing the impact to the corneal |
| | endothelial cells caused by the eye surgery. The ophthalmic |
| | composition comprises an ascorbic acid and a pharmaceutically |
| | acceptable ophthalmic carrier. |
| IPC | A61K 9/00 ; A61K 31/375 ; A61P 27/02 ; A61P 39/06 |

TABLE 6

| Patent or Publication | |
|---|---|
| Number | TWI822132 |
| Title | COURIER ASSISTANCE SYSTEM AND METHOD OF USING |
| | THE COURIER ASSISTANCE SYSTEM |
| Filing Date | Jun. 20, 2022 |
| Application No. | 111122870 |
| Patent Office | TW |
| Assignee | NATIONAL TAIPEI UNIVERSITY OF TECHNOLOGY |
| | <TAIPEI> (TW) |
| Inventors(s) | CHUNG, MING-AN (TW), CHAI, SUNG-YUN (TW), HSU, |
| | CHIA-CHUN (TW), CHEN, KAI-SHAWN (TW) |
| Abstract | The present invention provides a courier assistance system and a |
| | method of using the courier assistance system, including courier |
| | assistance glasses and a control device, the courier assistance glasses |
| | can collect environmental image data and environmental depth data, |
| | and transmit them to the control device for analysis, and the courier |
| | assistance glasses can receive an order data, navigation map data and |
| | indoor navigation map data transmitted by the control device are |
| | displayed. The present invention can allow delivery personnel or |
| | couriers to concentrate on driving to the target location without |
| | worrying about getting lost in the indoor space. |
| IPC | G06Q 50/28; G02B 27/02 |

In some embodiments, the processor 102 may build the database 1066 and classification models 1067 and 1068 using word vectors, first entries, and second entries with respect to Cases 1-2 to 1-6 in a manner similar to the procedure for Case 1-1, and thus the details thereof are not repeated here.

### Searching Procedure for Example 1

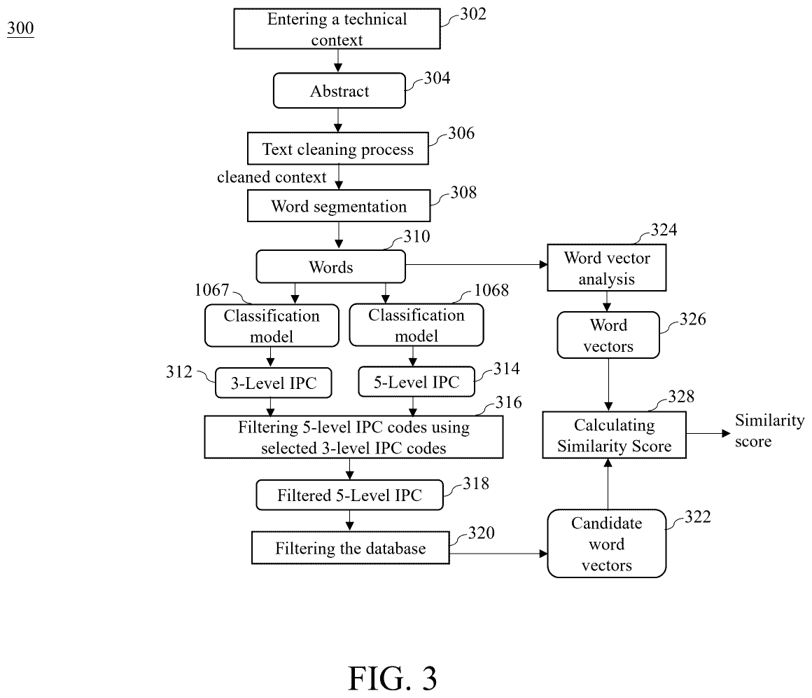

FIG. 3 is a flowchart of a search procedure for similar patent applications in accordance with some embodiments of the present disclosure.

In some embodiments, the user can enter a technical context into the computer device 100 (block 302) in order to find one or more similar patent applications within the remote database 20. The technical context may include an abstract 304 with or without a title. Additionally, the abstract 304 can also be a technical concept with rough or detailed description. For purposes of description, an example of the technical context includes both an abstract and a title, as shown in Table 7. Additionally, the technical context is accompanied with three IPC codes.

TABLE 7

| | |
|---|---|
| Title | Tooth implantation system and navigation method therefor |
| Abstract | A tooth implantation system and a navigation method therefor. The |
| | tooth implantation system comprises: a multi-axial robotic arm, |
| | having a tooth implantation apparatus attached at a functional end |
| | thereof; and at least one optical device, coupled to the multi-axial |
| | robotic arm to acquire real-time image information of a tooth |
| | implantation site of a patient in the process of tooth implantation. The |
| | multi-axial robotic arm drives the tooth implantation apparatus to |
| | operate on the tooth implantation site along a set route according to |
| | the result of association between a pre-implantation plan and the real- |
| | time image information. The pre-implantation plan is associated with |
| | a three-dimensional model of the tooth implantation site and |
| | comprises a set entry point, at least one set intermediate point and a |
| | set target point that are associated with the set route, and the three- |
| | dimensional model is constituted by pre-implantation image |
| | information of the tooth implantation site. |
| IPC | A61C 8/00(2006.01); A61B 34/10(2016.01); A61B 34/32(2016.01) |

In some embodiments, the processor 102 may execute the machine-learning model 1062 to perform a text cleaning process (block 306) on the abstract to obtain a cleaned context. Subsequently, the processor 102 may execute the machine-learning model 1064 to perform word segmentation (block 308) on the cleaned context to generate one or more words 310 associated with the abstract 304. For example, the words 310 may include terms such as “tooth implantation system”, “navigation method”, “multi-axial robotic arm”, “tooth implantation apparatus”, “functional end”, “optical device”, “real-time image information”, “tooth implantation site”, and so on.

In some embodiments, the processor 102 may utilize the trained classification model 1067 to identify the 3-level IPC codes 312 that are “hit” by the words 310, and calculate a first hit count for each 3-level IPC code 312. Similarly, the processor 102 may utilize the trained classification model 1068 to identify the 5-level IPC codes 314 that are “hit” by the words 310, and calculate a second hit count for each 5-level IPC code 314. It should be noted that a patent can have multiple IPC codes. 3-level IPC codes 312 are high-level or coarse IPC codes and, and tend to be more easily hit by the candidate words than the 5-level IPC codes 314. Thus, the first hit counts of the 3-level IPC codes 312 can be larger than the second hit counts of the 5-level IPC codes 314. Additionally, the processor 102 can calculate a first probability of each 3-level IPC code 312 and a second probability of each 5-level IPC code 314. For example, the first probability of each 3-level IPC code 312 can be calculated by dividing the first count thereof by the total first hit counts of all 3-level IPC codes 312 hit by the words 310. The second probability of each 5-level IPC code 314 can be calculated in a similar manner. Subsequently, the 3-level IPC codes 312 and 5-level IPC codes 314 corresponding to the abstract 304 can be organized into a first rank list and a second rank list using the first probabilities and the second probabilities, respectively.

The probability of each 3-level IPC code 312 in the first rank list is shown in Table 8 as follows.

TABLE 8

| 3-level IPC | Probability |
|---|---|
| A61B | 0.5596815627665142 |
| A61C | 0.15730287465208898 |
| H01F | 0.07561699162876472 |
| A61P | 0.05859667220716991 |
| A61K | 0.05859667220716991 |
| H03L | 0.05482839746715901 |
| H03B | 0.03537682907113368 |

In some embodiments, the processor 102 may then select a predetermined number (e.g., an integer between 2 and 4) of top 3-level IPC codes 312 from the first rank list. Alternatively, the processor 102 may then select the 3-level IPC codes 312 from the first rank list based on a predetermined percentage (e.g., 20%) of top first hit counts or using a Z-score technique, but the present disclosure is not limited thereto. For purposes of description, the top two 3-level IPC codes 312 in the first rank list are selected, namely, A61B and A61C.

Furthermore, the 5-level IPC codes 314 include A61B 34/20, A61B 90/50, A61B 6/14, A61C 1/08, A61B 19/00, and A61B 1/24. The probability for each 5-level IPC code 314 is shown in Table 9 as follows.

TABLE 9

| 5-level IPC | Probability |
|---|---|
| A61B 34/20 | 0.12174115915621976 |
| A61B 90/50 | 0.12174115915621976 |
| A61B 6/14 | 0.06310664168506087 |
| A61C 1/08 | 0.034231277962007145 |
| A61B 19/00 | 0.034231277962007145 |
| A61B 1/24 | 0.034231277962007145 |

In some embodiments, the processor 102 may filter the 5-level IPC codes 314 on the second rank list using the selected 3-level IPC codes 312 (e.g., A61B and A61C), thereby significantly reducing target patent applications to be retrieved from database 1066 (or remote database 20). Here, the six 5-level IPC codes 314 listed in Table 9 comply with the selected 3-level IPC codes 312. Specifically, database 1066 stores word vectors for Cases 1-1 to 1-6, and the processor 102 can retrieve the word vectors of three patent applications from database 1066 using the filtered 5-level IPC codes (e.g., including the six 5-level IPC codes in Table 9). Accordingly, the three patent applications retrieved from database 1066 can be regarded as candidate patent applications, as shown in Table 10.

TABLE 10

| Patent or Publication | | 5-level IPC | |
|---|---|---|---|
| Number | Title | code(s) | Similarity |
| U.S. Pat. No. 10687902B2 | Surgical Navigation System | A61B 34/20 | 0.17142857142857143 |
| | and Auxiliary Positioning | A61B 90/50 | |
| | Assembly Thereof | | |
| US20150140505A1 | COMPUTER-AIDED | A61B 1/24 | 0.15384615384615385 |
| | POSITIONING AND | A61B 19/00 | |
| | NAVIGATION SYSTEM | A61C 1/08 | |
| | FOR DENTAL IMPLANT | | |
| US20140080086A1 | Image Navigation Integrated | A61B 6/14 | 0.09302325581395349 |
| | Dental Implant System | | |

It should be noted that the patent application US20150140505A1 in Case 1-2 includes both the 3-level IPC codes of A61B and A61C. Afterwards, the processor 102 may calculate the similarity between the abstract 304 and each of the candidate patent applications. For example, the processor 102 may retrieve the candidate word vectors 322 (e.g., N-dimension vectors) corresponding to each of the candidate patent applications in Table 10 from the database 1066. Additionally, the processor 102 may execute the machine-learning model 1065 to perform word vector analysis (block 324) of the words 310 to obtain a plurality of word vectors 326. Then, the processor 102 may calculate similarities (e.g., cosine similarities) between the word vectors (also N-dimension vectors) of the abstract 304 and the candidate word vectors 322 of each candidate patent application (block 328) to determine a similarity score for each candidate patent application.

In some embodiments, each candidate patent application may have its own similarity score. A higher similarity score of a particular candidate patent application may indicate a higher similarity to the input technical context. However, the processor 102 may determine the patent application(s) most similar to the input technical context based on the similarity score and coverage of IPC codes of each candidate patent application. For example, the candidate patent application U.S. Ser. No. 10/687,902B2 has the highest similarity score among these candidate patent applications, but it only covers one 3-level IPC code of “A61”. On the other hand, the candidate patent application US20150140505A1 has the second highest similarity score and the highest coverage of IPC codes, covering two 3-level IPC codes of “A61i” and “A61C”, while the candidate patent application U.S. Ser. No. 10/687,902B2 only covers one 3-level IPC codes. Thus, the processor 102 may select the candidate patent application(s) with the highest coverage of 3-level IPC codes, and determine the selected candidate patent application with the highest similarity score as the most similar patent application corresponding to the input technical context. Alternatively, in some embodiments, the processor 102 will give more weight to the similarity score based on the coverage of each candidate patent application, such as multiplying the similarity score by the number of covered 3-level IPC code(s). For example, the similarity scores of the candidate patent applications US20150140505A1 and U.S. Ser. No. 10/687,902B2 will be multiplied by “2” and “1”, respectively, resulting in the candidate patent application US20150140505A1 having the highest weighted similarity score. Therefore, the processor 102 will determine that the candidate patent application US20150140505A1, which has the highest weighted similarity score, is the most similar patent application corresponding to the input technical context.

In view of the above, the technique described in Example 1 is capable of automatically retrieving similar patent applications based on a technical context. As a result, this approach reduces the complexity and time required for the search process. The search for similar patent applications utilizes different ranges of IPC codes (e.g., 3-level IPC codes and 5-level IPC codes) within each patent application retrieved from the remote database 20. Furthermore, a high-level field (e.g., 3-level IPC codes) can be utilized to perform a coarse filtering of potential patent applications, and then to filter a low-level field (e.g., 5-level IPC codes) to refine the filter results of potential patent applications, thereby enhancing the accuracy of the search results. Therefore, the technique of the present disclosure offers more efficient and convenient retrieval of information for similar patent applications with higher accuracy, achieving a better user experience.

### Example 2: Searching for Similar Medical Devices Using Technical Context

In some embodiments, the techniques described in Example 1 can also be used to search for similar medical devices using a technical context. In Example 2, the application program 1061 may include instructions to be executed by the processor 102 perform operations for retrieving information for similar medical devices based on a technical context, as will further explained. The technical context can involve an abstract technical description of a particular medical device either in development or not yet approved by regulatory authorities, such as the Food and Drug Administration (FDA) in the United States or similar authorities in other jurisdictions.

### Training Procedure for Example 2

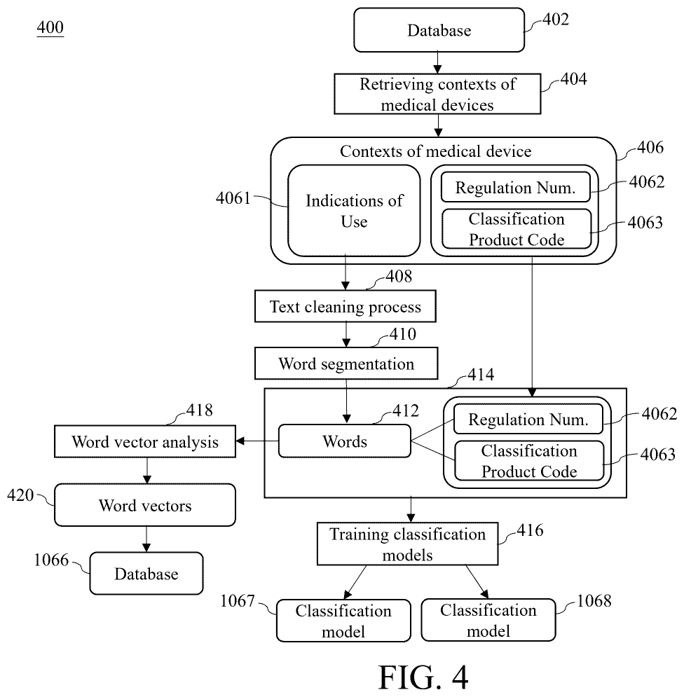

FIG. 4 is a flowchart of a training procedure for similar medical devices in accordance with some embodiments of the present disclosure.

In some embodiments, during training procedure 400, the processor 102 may retrieve contexts 406 of a plurality of medical devices from database 402 (step 404). For example, database 402 may be a searchable database initiated by the FDA, such as a 510(k) database or the OpenFDA database. Database 402 may include premarket notification forms and documentation submitted by medical device companies to the FDA. Additionally, the context 406 of each medical device may include a 510(k) number, a device name, applicant(s), a regulation number, a classification product code (i.e., product code in short), indications for use, etc. The processor 102 may execute the machine-learning model 1062 to perform a text cleaning process (block 408) to remove adverbs, punctuations (e.g., periods, commas, question marks), stopwords, and other unnecessary elements (e.g., accent marks, diacritics, etc.) from the contexts 406 of medical devices retrieved from database 402, so primary technical content and/or keywords will be retained in the raw text of the cleaned context. Subsequently, the processor 102 may then execute the machine-learning model 1064 to perform word segmentation (block 410) on the description of indications of use 4061 (i.e., abbreviated as “IOU”) within the cleaned context to generate a plurality of words 412 associated with the description of indications of use 4061.

In some embodiments, the processor 102 may obtain a variety of first entries by pairing each word 412 and each regulation number 4062 found in the context 406 of each medical device (block 414), allowing the processor 102 to train (or build) a classification model 1067 using the first entries (block 416). Additionally, the processor 102 may obtain a variety of second entries by pairing each word 412 and each product code 4063 found in the context 406 of each medical device (block 414), allowing the processor 102 to build the classification model 1068 using the second entries (block 416).

In some embodiments, the processor 102 may execute the machine-learning model 1065 to conduct word vector analysis (block 418) on the words 412 generated by the machine-learning model 1064 to generate a plurality of word vectors 420 associated with the words 412 within the description of indications of use 4061 for each medical device, and build the database 1066 using the generated word vectors 420.

For purposes of description, Cases 2-1 to 2-6 are used during the training procedure in Example 2. Table 11 illustrates information for Case 2-1 retrieved from the remote database 20.

TABLE 11

| | |
|---|---|
| 510(k) Number | K212397 |
| Device Name | StealthStation S8 Cranial v2.0 |
| Applicant | Medtronic Navigation |
| Regulation Number | 882.4560 |
| Classification | HAW |
| Product Code | |
| Indications for Use | The StealthStation ™ System, with StealthStation ™ Cranial |
| | Software, is intended as an aid for locating anatomical structures in |
| | either open or percutaneous neurosurgical procedures. Their use is |
| | indicated for any medical condition in which the use of stereotactic |
| | surgery may be appropriate, and where reference to a rigid |
| | anatomical structure, such as the skull, can be identified relative to |
| | images of the anatomy. This can include, but is not limited to, the |
| | following cranial procedures (including stereotactic frame-based and |
| | stereotactic frame alternatives-based procedures): • Tumor |
| | resections • General ventricular catheter placement • Pediatric |
| | ventricular catheter placement • Depth electrode, lead, and probe |
| | placement • Cranial biopsies. |

In some embodiments, with regard to Case 2-1 shown in Table 11, the processor 102 may execute the machine-learning model 1062 to perform a text cleaning process on description of indications of use 4061 in Case 2-1. The processor 102 may then execute the machine-learning model 1064 to perform word segmentation (block 410) on the cleaned context to generate a plurality of IOU words 412, such as “StealthStation™ System”, “StealthStation™ Cranial Software”, “anatomical structures”, “percutaneous neurosurgical procedures”, “medical condition”, “stereotactic surgery”, “rigid anatomical structure”, etc.

In some embodiments, the processor 102 may generate the first entries for the classification model 1067 by pairing each of the IOU words and the regulation number (e.g., 882.4560) (block 414). For example, the first entries may include the following combinations, such as (“StealthStation™ System”, “882.4560”), (“StealthStation™ Cranial Software”, “882.4560”), (“anatomical structures”, “882.4560”), and others. Additionally, the processor 102 may further generate the second entries for the classification model 1068 by pairing each of the IOU words and the classification product code (e.g., HAW) (block 414). For example, the second entries may include the following combinations, such as (“StealthStation™ System”, “HAW”), (“StealthStation™ Cranial Software”, “HAW”), (“anatomical structures”, “HAW”), (“percutaneous neurosurgical procedures”, “HAW”), and others. Therefore, the processor 102 can train (or build) the classification models 1067 and 1068 using the first entries and the second entries, respectively (block 416).

In some embodiments, the processor 102 may execute the machine-learning model 1065 to conduct word vector analysis (block 418) on each IOU word 412 to generate a word vector 420 for each IOU word. For example, the machine-learning model 1065 may convert each IOU word 412 into a respective word vector 420 using the technique of“word to vector” (e.g., Word2vec), with each word vector having N dimensions, where N is a positive integer. Accordingly, the processor 102 can store the word vectors 420 corresponding to Case 2-1 to the database 1066.

Tables 12 to 16 illustrate information for Cases 2-2 to 2-6 retrieved from the remote database 20, respectively.

TABLE 12

| | |
|---|---|
| 510(k) Number | K212194 |
| Device Name | Stryker Q Guidance System |
| Applicant | Stryker Corporation |
| Regulation Number | 882.4560 |
| Classification | HAW |
| Product Code | |
| Indications for Use | The Stryker Q Guidance System, with the Cranial Guidance |
| | Software, is intended as a planning and intraoperative guidance |
| | system to enable open or percutaneous computer-assisted surgery. |
| | The system is indicated for any medical condition in which the use |
| | of computer-assisted planning and surgery may be appropriate. The |
| | system can be used for intraoperative guidance where a reference to |
| | a rigid anatomical structure can be identified. The system assists in |
| | the positioning of instruments for cranial procedures, including: • |
| | Cranial biopsies • Craniotomies • Craniectomies • Resection of |
| | tumors and other lesions • Skull base procedures • Transnasal |
| | neurosurgical procedures • Transsphenoidal pituitary surgery • |
| | Craniofacial procedures • Skull reconstruction procedures • Orbital |
| | cavity reconstruction procedures • General ventricular catheter and |
| | shunt placement •Pediatric ventricular catheter and shunt placement. |

TABLE 13

| | |
|---|---|
| 510(k) Number | K102650 |
| Device Name | CYBERKNIFE ROBOTIC RADIOSURGERY SYSTEM |
| Applicant | ACCURAY INCORPORATED |
| Regulation Number | 892.5050 |
| Classification | IYE |
| Product Code | |
| Indications for Use | The CyberKnife ® Robotic Radiosurgery System and CyberKnife |
| | VSI~ Robotic Radiosurgery System are indicated for treatment |
| | planning and image guided stereotactic radiosurgery and precision |
| | radiotherapy for lesions, tumors and conditions anywhere in the body |
| | when radiation treatment is indicated. |

TABLE 14

| | |
|---|---|
| 510(k) Number | K223311 |
| Device Name | Philips CT 3500 |
| Applicant | Philips Healthcare (Suzhou) Co., Ltd. |
| Regulation Number | 892.1750 |
| Classification | JAK |
| Product Code | |
| Indications for Use | The Philips CT 3500 is a Computed Tomography X-Ray System |
| | intended to produce images of the head and body by computer |
| | reconstruction of X-Ray transmission data taken at different angles |
| | and planes. These devices may include signal analysis and display |
| | equipment, patient and equipment supports, components and |
| | accessories. The Philips CT 3500 is indicated for head, whole body, |
| | cardiac (Cardiac Calcium Scoring) and vascular X-ray Computed |
| | Tomography applications in patients of all ages. These scanners are |
| | intended to be used for diagnostic imaging and for low dose CT lung |
| | cancer screening for the early detection of lung nodules that may |
| | represent cancer*. The screening must be performed within the |
| | established inclusion criteria of programs/protocols that have been |
| | approved and published by either a governmental body or |
| | professional medical society. |

TABLE 15

| | |
|---|---|
| 510(k) Number | K180586 |
| Device Name | Varian Head Frame |
| Applicant | Varian Medical Systems, Inc. |
| Regulation Number | 892.5050 |
| Classification | IYE |
| Product Code | |
| Indications for Use | The Varian Head Frame System is for use with a computed |
| | tomography scanner to perform imaging for treatment planning and |
| | a charged particle accelerator to perform immobilization of the |
| | treatment target for stereotactic radiosurgery or radiotherapy |
| | treatments on cranial lesions, tumors and conditions where radiation |
| | treatment is indicated. |

TABLE 16

| | |
|---|---|
| 510(k) Number | K192133 |
| Device Name | Zimmer Biomet Universal Navigation System |
| Applicant | Zimmer Biomet Spine, Inc. |
| Regulation Number | 882.4560 |
| Classification | OLO |
| Product Code | |
| Indications for Use | The Zimmer Biomet Universal Navigation System is indicated for |
| | use during the preparation and insertion of Zimmer Biomet screws |
| | during spinal surgery to assist the surgeon in precisely locating |
| | anatomical structures in either open or minimally invasive |
| | procedures. The universal adaptors are specifically designed for use |
| | with the Zimmer Biomet ROSA One Spine System, which is |
| | indicated for providing spatial positioning and orientation of |
| | instrument holders or tool guides based upon an intraoperative plan |
| | developed with three dimensional imaging software provided that the |
| | required fiducial markers and rigid patient anatomy can be identified |
| | on 3D CT scans. The ROSA One Spine System is intended for the |
| | placement of pedicle screws in vertebrae with a posterior approach in |
| | the thoracolumbar region. |

In some embodiments, the processor 102 may build the database 1066 and train the classification models 1067 and 1068 using word vectors, first entries, and second entries with respect to Cases 2-2 to 2-6 in a manner similar to the procedure described in the embodiment for Case 2-1, and thus the details thereof are not repeated here.

### Search Procedure for Example 2

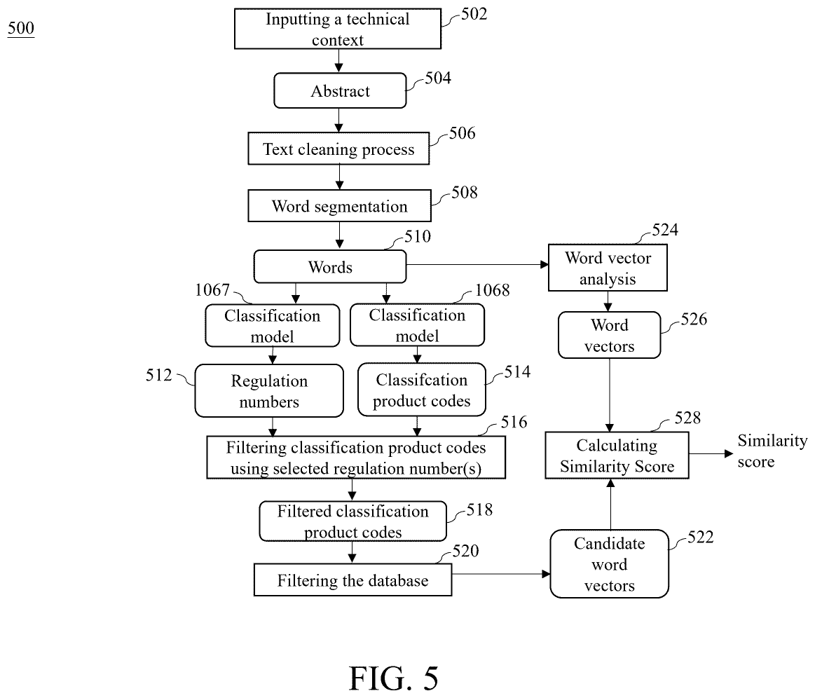

FIG. 5 is a flowchart of a search procedure for similar medical devices in accordance with some embodiments of the present disclosure.

In some embodiments, the user can enter a technical context associated with a particular medical device into the computer device 100 (block 502) find one or more similar medical devices within the remote database 20. The technical context may include an abstract with or without a title. Additionally, the abstract can also be a technical concept with rough or detailed description of the particular medical device. For purposes of description, an example of the technical context includes an abstract without the title, as shown in Table 17. Additionally, the technical context is accompanied with a regulation number and a classification product code.

TABLE 17

| | |
|---|---|
| Title | N/A |
| Abstract | This system provides a computer-assisted guidance technology for |
| | brain and neurosurgical operations, utilizing digital medical imaging |
| | and precise positioning devices to achieve efficient and safe surgical |
| | execution. The core of the system lies in its ability to integrate |
| | multiple sources of digital imaging data, such as MR and CT scans, |
| | to conduct accurate three-dimensional positioning, offering surgeons |
| | detailed surgical plans and real-time navigation to ensure surgical |
| | precision. This technology not only improves the success rate of |
| | surgeries but also maximizes patient safety, representing a significant |
| | technological advancement in the field of brain and neurosurgery. |
| Regulation Number | 882.4560 |
| Classification | HAW |
| Product Code | |

In some embodiments, the processor 102 may execute the machine-learning model 1062 to perform a text cleaning process (block 506) on the abstract 504 to obtain a cleaned context. Subsequently, the processor 102 may execute the machine-learning model 1064 to perform word segmentation (block 508) on the cleaned context to generate one or more words 510 associated with the abstract 504. For example, the words 510 may include terms such as “computer-assisted guidance technology”, “brain and neurosurgical operations”, “digital medical imaging”, “precise positioning devices”, “digital imaging data”, “MR”, “CT scans”, “three-dimensional positioning”, and others.

In some embodiments, the processor 102 may utilize the trained classification model 1067 to identify the regulation numbers 512 that are “hit” by the words 510, and calculate a first hit count for each regulation number. Similarly, the processor 102 may also utilize the trained classification model 1068 to identify the classification product codes 514 that are “hit” by the words 510, and calculate a second hit count for each classification product code 514. Additionally, the processor 102 can calculate a first probability of each regulation number 512 and a second probability of each classification product code 514. For example, the first probability of each regulation number 512 can be calculated by dividing the first count thereof by the total first hit counts of all regulation numbers hit by the words 510. The second probability of each classification product code 514 can be calculated in a similar manner. Subsequently, the regulation numbers 512 and classification product codes 514 corresponding to the abstract 504 can be organized into a first rank list and a second rank list using the first probabilities and the second probabilities, respectively.

The probability of each regulation number in the first rank list is shown in Table 18 as follows.

TABLE 18

| Regulation Number | Probability |
|---|---|
| 882.4560 | 0.5361721847484682 |
| 892.5050 | 0.32250527779208066 |
| 892.1750 | 0.1413225374594512 |

In some embodiments, the processor 102 may then select a predetermined number (e.g., an integer between 1 and 2) of top regulation numbers from the first rank list. Alternatively, the processor 102 may then select the regulation numbers from the first rank list based on a predetermined percentage (e.g., 20%) of top first hit counts or using a Z-score technique, but the present disclosure is not limited thereto. For purposes of description, the top one regulation numbers in the first rank list is selected, namely, 882.4560.

Furthermore, the classification product codes include HAW, IYE, OLO, and JAK. The probability of each classification product code is shown in Table 19 as follows.

TABLE 19

| Classification | |
|---|---|
| Product Code | Probability |
| HAW | 0.6005132226017779 |
| IYE | 0.17091530181742887 |
| OLO | 0.15367600624506575 |
| JAK | 0.07489546933572733 |

In some embodiments, the processor 102 may filter the classification product codes 514 on the second rank list using the selected regulation number 512 (e.g., 882.4560) (block 516), and the filtered classification product codes 518 includes HAW and OLO. As a result, the number of target medical device cases to be retrieved from the database 1066 can be significantly reduced. Specifically, the database 1066 includes word vectors corresponding to Cases 2-1 to 2-6, and the processor 102 can retrieve the candidate word vectors 522 of two medical device cases, which are hit by each of the filtered classification product codes (e.g., HAW and OLO), from the database 1066 (block 520). Accordingly, the two medical device cases retrieved from the remote database 20 can be regarded as candidate medical device cases, as shown in Table 20.

TABLE 20

| Patent or | | | |
|---|---|---|---|
| Publication | Regulation | Classification | |
| Number | Number | Product Code | Similarity |
| StealthStation S8 | 882.4560 | HAW | 0.04081632653061224 |
| Cranial v2.0 | | | |
| Stryker Q Guidance | 882.4560 | HAW | 0.0784313725490196 |
| System | | | |

Afterwards, the processor 102 may calculate the similarity between the abstract 504 and each of the candidate medical device cases. For example, the processor 102 may retrieve the word vectors (e.g., N-dimension vectors) corresponding to each of the candidate medical device cases in Table 20 from the database 1066. Additionally, the processor 102 may execute the machine-learning model 1065 to perform word vector analysis (block 524) on the words 510 to obtain a plurality of word vectors 526. The processor 102 may calculate similarities (e.g., cosine similarities) between the word vectors 526 (also N-dimension vectors) of the abstract 504 and the candidate word vectors 522 of each candidate medical device case to determine a similarity score for each candidate medical device case (block 528).

In some embodiments, each medical device case may have its own similarity score. A higher similarity score of a particular candidate medical device case may indicate a higher similarity to the input technical context. However, the processor 102 may determine the medical device case(s) most similar to the input technical context based on the similarity score and coverage of the regulation number of each candidate patent application. For example, although two medical device cases are listed in Table 20, these medical device cases may not have the highest similarity scores. For example, the medical device “Philips CT 3500” in Case 2-4 has the highest similarity score of 0.08333333333333333 among Cases 2-1 to 2-6. However, the regulation number of this medical device is 892.1750, which does not comply with the selected regulation number (e.g., 882.4560) (i.e., uncovered by the selected regulation number), resulting in Case 2-4 being filtered out during the search procedure. Therefore, the processor 102 will determine that the candidate medical device case with the highest similarity score in Table 20 as the most similar patent application corresponding to the input technical context, namely, “Stryker Q Guidance System”.

Therefore, in Example 2, the user can simply enter a technical context, which could be coarse technical concept with or without a title and regulation numbers, into the computer device 100, and the computer device 100 can automatically search for one or more medical device cases similar to the technical context.

In view of the above, the technique described in Example 2 is capable of automatically retrieving information for similar medical devices based on a technical context of the specific medical device. As a result, this approach reduces the complexity and time required for the search process. The search for similar medical devices utilizes different fields (e.g., regulation number and classification product code) within each medical device case retrieved from the remote database. Furthermore, a high-level field can be utilized to perform a coarse filtering of potential medical device case, and then to filter a low-level field to refine the filter results of potential medical device cases, thereby enhancing the accuracy of the search results. Therefore, the technique described in the present disclosure offers a more efficient and convenient way for the user to retrieve information for similar medical devices with higher levels of accuracy, achieving a better user experience.

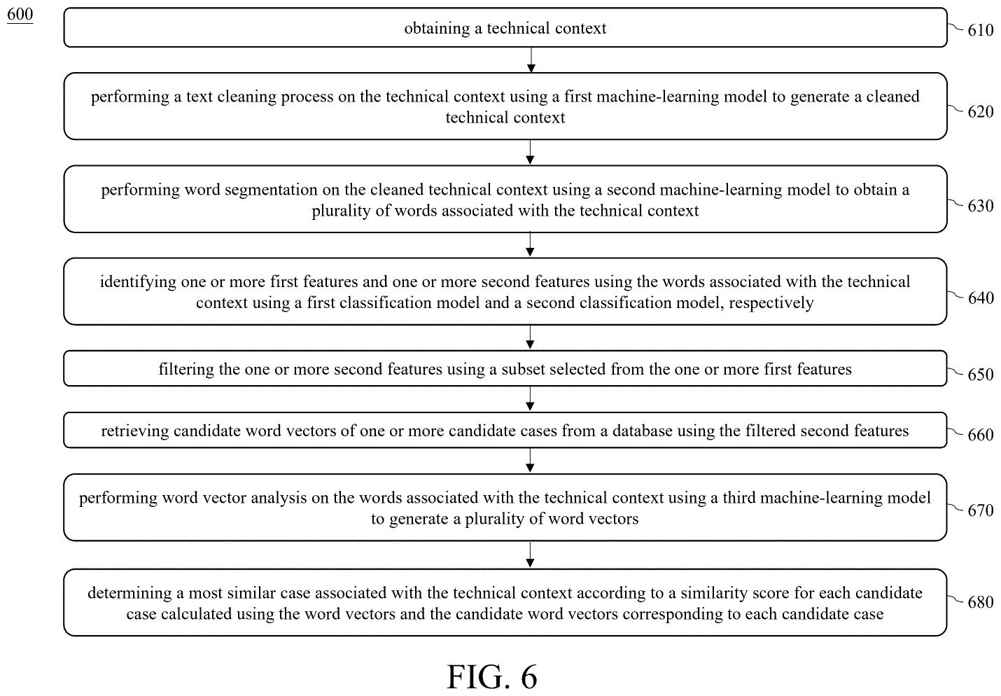

FIG. 6 is a flowchart of a method for retrieving information for similar cases in accordance with some embodiments of the present disclosure.

In an embodiment, the method 600 for retrieving information for similar cases may include steps 610 to 680. Additionally, the method 600 encompasses a broader concept of Examples 1 and 2, and can be extended to other appropriate cases in addition to patent applications and medical device cases. Step 610: Obtaining a technical context. For example, the technical context may be associated with a technical concept or a specific medical device. The technical context may be in the form of an abstract or technical description with or without a title.

Step 620: Performing a text cleaning process on the technical context using a first machine-learning model to generate a cleaned technical context. For example, the first machine-learning model may be the machine-learning model 1062. The machine-learning model 1062 used in this process may be a natural language processing (NLP) model that can identify relationships between the various elements of language, such as the letters, words, phrases, and sentences present within in the first technical context. Additionally, the machine-learning model 1062 is capable of identifying and removing adverbs, punctuations, stopwords, and other unwanted elements from the first technical context, thereby facilitating the text cleaning process. In some embodiments, step 620 can be omitted, and the processor 102 can perform step 630 directly on the technical context.

Step 630: Performing word segmentation on the cleaned technical context using a second machine-learning model to obtain a plurality of words associated with the technical context. For example, the second machine-learning model may be the machine-learning model 1064. Alternatively, the second machine-learning model can be the remote machine-learning model 30 shown in FIG. 1.

Step 640: Identifying one or more first features and one or more second features using the words associated with the technical context using a first classification model and a second classification model, respectively. For example, the first features and second features can be 3-level IPC codes and 5-level IPC codes in Example 1, respectively. Alternatively, the first features and second features can also be regulation numbers and classification product codes in Example 2. In some embodiments, the first features and second features can be organized into a first rank list and a second rank list according to a first probability of each first feature and a second probability of each second feature, respectively. It should be noted that although the first features and second features are mentioned, third features (or more features) other than first features and second features can be employed in the flow for retrieving information for similar cases provided in the present disclosure. In some embodiments, third features can be used as another coarse filtering together with the first features, and the candidate case(s) can be retrieved by filtering the second features using the first features and third features. In some embodiments, third features can be used as another finer filtering together with the second features, and the candidate case(s) can be retrieved by filtering the first features using the second features and third features.

Step 650: filtering the one or more second features using a subset selected from the one or more first features. For example, the processor 102 may select a predetermined number of first features from the first rank list (e.g., top ranked first features). Alternatively, the processor may select the first features from the first rank list based on a predetermined percentage of top hit counts or using a Z-score technique. Subsequently, the processor 102 may filter the second features using the subset selected from the first features, thereby reducing the number of candidate cases to be retrieved from database 1066.

Step 660: retrieving candidate word vectors of one or more candidate cases from a database using the filtered second features. For example, one or more candidate cases and their respective word vectors can be retrieved from database 1066 based on the filtered second features.

Step 670: performing word vector analysis on the words associated with the technical context using a third machine-learning model to generate a plurality of word vectors. For example, the third-machine-learning model may be the machine-learning model 1065.

Step 680: determining a most similar case associated with the technical context according to a similarity score for each candidate case calculated using the word vectors and the candidate word vectors corresponding to each candidate case. For example, the similarity score may be a cosine similarity value between the word vectors associated with the technical context and the candidate word vectors corresponding to each candidate case. In some embodiments, the processor may determine the most similar case of the technical context based on the similarity score and coverage of the first features of each candidate case. In other words, the candidate case with the highest similarity score is not necessarily the most similar case.

The scope of the present disclosure is not intended to be limited to the particular embodiments of the process, machine, manufacture, and composition of matter, means, methods, steps, and operations described in the specification. As those skilled in the art will readily appreciate from the disclosure of the present disclosure, processes, machines, manufacture, composition of matter, means, methods, steps, or operations presently existing or later to be developed that perform substantially the same function or achieve substantially the same result as the corresponding embodiments described herein may be utilized according to the present disclosure. Accordingly, the appended claims are intended to include within their scope processes, machines, manufacture, and compositions of matter, means, methods, steps, or operations. In addition, each claim constitutes a separate embodiment, and the combination of various claims and embodiments are within the scope of the disclosure.

The methods, processes, or operations according to embodiments of the present disclosure can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of the present disclosure.

An alternative embodiment preferably implements the methods, processes, or operations according to embodiments of the present disclosure on a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor, but the instructions may alternatively or additionally be executed by any suitable dedicated hardware device. For example, an embodiment of the present disclosure provides a non-transitory, computer-readable storage medium having computer programmable instructions stored therein.

While the present disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be able to make and use the teachings of the present disclosure by simply employing the elements of the independent claims. Accordingly, embodiments of the present disclosure as set forth herein are intended to be illustrative, not limiting. Various changes may be made without departing from the spirit and scope of the present disclosure.

Even though numerous characteristics and advantages of the present disclosure have been set forth in the foregoing description, together with details of the structure and function of the invention, the disclosure is illustrative only. Changes may be made to details, especially in matters of shape, size, and arrangement of parts, within the principles of the invention to the full extent indicated by the broad general meaning of the terms in which the appended claims are expressed.

1. A method for retrieving information for similar cases, the method comprising:
obtaining a technical context;
performing a text cleaning process on the technical context using a first machine-learning model to generate a cleaned technical context;
performing word segmentation on the cleaned technical context using a second machine-learning model to obtain a plurality of words associated with the technical context;
identifying one or more first features and one or more second features using the words associated with the technical context using a first classification model and a second classification model, respectively;
filtering the one or more second features using a subset selected from the one or more first features;
retrieving candidate word vectors of one or more candidate cases from a database using the filtered second features;
performing word vector analysis on the words associated with the technical context using a third machine-learning model to generate a plurality of word vectors; and
determining a most similar case associated with the technical context according to a similarity score for each candidate case calculated using the word vectors and the candidate word vectors corresponding to each candidate case, wherein:
the technical context comprises a description of a technical concept;
the first features and the second features are 3-level IPC (international patent classification) codes and 5-level IPC codes, respectively; and
the database comprises a plurality of word vectors of a plurality of patent applications retrieved from a patent database.

2. (canceled)

3. (canceled)

4. The method of claim 1, wherein the step of filtering the one or more second features using the subset selected from the one or more first features comprises:
calculating a first hit count of each 3-level IPC code hit by the words associated with the technical context;
calculating a first probability of each 3-level IPC code according to the first hit count of each 3-level IPC code;
organizing the one or more 3-level IPC codes into a first rank list; and
selecting a predetermined number of top ranked 3-level IPC codes from the first rank list.

5. (canceled)

6. (canceled)

7. A method for retrieving information for similar cases, the method comprising:
obtaining a technical context;
performing a text cleaning process on the technical context using a first machine-learning model to generate a cleaned technical context;
performing word segmentation on the cleaned technical context using a second machine-learning model to obtain a plurality of words associated with the technical context;
identifying one or more first features and one or more second features using the words associated with the technical context using a first classification model and a second classification model, respectively;
filtering the one or more second features using a subset selected from the one or more first features;
retrieving candidate word vectors of one or more candidate cases from a database using the filtered second features;
performing word vector analysis on the words associated with the technical context using a third machine-learning model to generate a plurality of word vectors; and
determining a most similar case associated with the technical context according to a similarity score for each candidate case calculated using the word vectors and the candidate word vectors corresponding to each candidate case, wherein the technical context comprises a description of indications of use of a specific medical device, the first features and the second features are regulation numbers and classification product codes of medical devices, respectively, and the database comprises a plurality of word vectors of a plurality of medical device cases retrieved from a medical device database.

8. (canceled)

9. The method of claim 7, wherein the step of filtering the one or more second features using the subset selected from the one or more first features comprises:
calculating a first hit count of each regulation number hit by the words associated with the technical context;
calculating a first probability of each regulation number according to the first hit count of each regulation number;
organizing the regulation numbers into a first rank list; and
selecting a predetermined number of top ranked regulation numbers from the first rank list.

10. (canceled)

11. A computer device for retrieving information for similar cases, the computer device comprising:
a memory having computer executable instructions stored therein; and
a processor coupled to the memory,
wherein the computer executable instructions cause the processor to perform operations, and the operations comprise:
obtaining a technical context;
performing a text cleaning process on the technical context using a first machine-learning model to generate a cleaned technical context;
performing word segmentation on the cleaned technical context using a second machine-learning model to obtain a plurality of words associated with the technical context;
identifying one or more first features and one or more second features using the words associated with the technical context using a first classification model and a second classification model, respectively;
filtering the one or more second features using a subset selected from the one or more first features;
retrieving candidate word vectors of one or more candidate cases from a database using the filtered second features;
performing word vector analysis on the words associated with the technical context using a third machine-learning model to generate a plurality of word vectors; and
determining a most similar case associated with the technical context according to a similarity score for each candidate case calculated using the word vectors and the candidate word vectors corresponding to each candidate case, wherein:
the technical context comprises a description of a technical concept;
the first features and the second features are 3-level IPC (international patent classification) codes and 5-level IPC codes, respectively; and
the database comprises a plurality of word vectors of a plurality of patent applications retrieved from a patent database.

12. (canceled)

13. (canceled)

14. The computer device of claim 11, wherein the operation of filtering the one or more second features using the subset selected from the one or more first features comprises:
calculating a first hit count of each 3-level IPC code hit by the words associated with the technical context;
calculating a first probability of each 3-level IPC code according to the first hit count of each 3-level IPC code;
organizing the one or more 3-level IPC codes into a first rank list; and
selecting a predetermined number of top ranked 3-level IPC codes from the first rank list.

15-20. (canceled)
